(19) United States
(12) Patent Application Publication
(10) Pub. No.: US 2024/0163667 A1
(43) Pub. Date: May 16, 2024

(54) REMOTE INSTRUMENT CONTROL AND FLEET MANAGEMENT

(71) Applicant: MERCK PATENT GMBH, DARMSTADT (DE)

(72) Inventor: Luc FELDEN, Molsheim (FR)

(73) Assignee: MERCK PATENT GMBH, DARMSTADT (DE)

(21) Appl. No.: 18/284,448

(22) PCT Filed: Mar. 29, 2022
(86) PCT No.: PCT/EP2022/058185

§ 371 Date: Sep. 27, 2023

(30) Foreign Application Priority Data
Mar. 31, 2021 (EP) 21305415.8

(51) Int. Cl. H04W 12/06; H04L 67/125; H04W 12/47; H04W 12/50

(52) U.S. Cl. CPC H04W 12/06; H04L 67/125; H04W 12/47; H04W 12/50

(57) ABSTRACT

Method and System to remote control different electronic instruments (2) by using a mobile computer device (1) with a software (7) including a compatible graphical user interface (5), which comprises the following steps of Login and Authentication of a user (3) at the mobile device (1); Pairing of an electronic instrument (2) with the mobile device (1) to identify the instrument (2) by the user (3); Performing an security check by the mobile device (1) if the authenticated user (3) is authorized to control the identified instrument (2); If the user (3) is authorized pairing of the mobile device (1) with the instrument (2) via a data connection, loading of the correct compatible graphical user interface (5) of the paired instrument (2) and displaying it at the screen of the mobile device (1); and Remote controlling of the instrument (2) by using the graphical user interface (5) displayed on the mobile device (1).

The hereby described invention discloses a method to remote control different electronic instruments with a mobile computer device including a software with a graphical user interface.

### TECHNICAL FIELD

The invention deals with the technological area of electronic instrument supervision.

### BACKGROUND AND DESCRIPTION OF THE PRIOR ART

Electronical instruments e.g. for the purpose of measuring various physical parameters are nowadays widely used. Those instruments vary from simple voltmeters over distance meter until fully equipped mass spectrographs and the like. Those instruments have currently usually a display or keypad as user interface or Human Machine Interface in order to allow interactions between the human user and the instrument.

In the Pharma and Food & Beverage industrial context and its respective instruments it is additionally often necessary for those instruments to offer a user management and provide a specific traceability along the workflow in order to comply with GxP and/or regulatory needs. Therefore the instrument providers often built use logging and password protected accounts in their products.

This leads to a problem that in a standard chemical laboratory as it is used in the Pharma and Food industry many different instruments are used which all have their own proprietary user interface often including its own user account with all different requirements regarding user name, password and so on. That results in huge efforts to handle all those accounts and different interfaces which greatly reduces the work efficiency of the users, respectively the lab workers.

It would therefore be of great helpfulness for the users to provide a way to align all those different user interfaces.

A known related approach in the state of the art is to control Programmable Logic Controllers (PLC) remotely through the web via a browser based graphical user interface (GUI).

Another example is the direct access of an instrument through a network. Those approaches unfortunately do not provide an anchoring function which holds on to the dedicated device and they do provide a full traceability on the lab.

A further example is a flying drone which is controlled by a mobile device. If you consider that as a kind of an instrument it provides a remote control and command. But here again an anchoring and traceability function is not disclosed in these products.

### SUMMARY OF THE INVENTION

The task of this patent application is therefore to find a method and a system which is able to control completely different electronical instruments with different user interfaces.

This task has been solved by a method to remote control different electronic instruments by using a mobile computer device with a software including compatible graphical user interfaces, which comprises the steps of login and authentication of a user at the mobile device; pairing of an electronic instrument with the mobile device to identify the instrument by the user; performing an security check by the mobile device if the authenticated user is authorized to control the identified instrument; if the user is authorized pairing of the mobile device with the instrument via a data connection and loading the correct compatible graphical user interface of the paired instrument and displaying it at the screen of the mobile device; remote controlling of the instrument by; and using the graphical user interface displayed on the mobile device. Core of the invention is the approach that with one single mobile device, e.g. a normal smartphone, a user is enabled to connect to different instruments, from the same type as well as different types. This offers a lot of opportunities. It is for instance possible to get rid of the fully featured user interface implemented in the instrument directly. This is possible by the software which is executed on the mobile and provides a GUI which is adapted to the needs of the respective remote controlled instrument. To do so the software needs to get the information about what kind of instrument shall be remote controlled which can be provided via different ways. This is done by pairing the mobile device with the instrument. The flexibility of data interfaces from a mobile device like a smartphone can be used here. A smartphone for instance provides usually a camera which can be used to scan printed informations or use its Bluetooth, NFC, Mobile Data (3G/4G/5G/ . . . ) or Wifi data interfaces. In case of connecting to the instrument directly with a cable the pairing step is not required as the instrument is then already known. When the instrument is successfully identified and the user is recognized via an authentification process the software on the mobile device loads the suitable GUI. The different GUIs can be saved on the mobile device or be provided via a database which is connected to the mobile device via its data interfaces. It could also be performed on and simply transferred from the instrument. This is possible because a data connection between instrument and mobile device is anyway required to exchange the control inputs from the user for the instrument and send status data from the instrument to the mobile device. It can also be a generic GUI with generic command and control, like start and stop of a measurement and status of the instrument, e.g. ready or not.

Advantageous and therefore preferred further developments of this invention emerge from the associated subclaims and from the description and the associated drawings.

One of those preferred further developments of the disclosed method comprise that the login step is performed by using LDAP and/or a double authentication process. As these login techniques are often already implemented for the users of the instruments it saves a lot of work to use them for login process at the mobile device as well. If the user is not authorized to use the instrument he gets a respective notification and is denied access. Otherwise the login is successful and he will be able to control the instrument.

Another one of those preferred further developments of the disclosed method comprise that a terminal portable cover is applied to the mobile device that protects it from outside influences. As lots of instruments are used in a delicate environment, like laboratories, a protection outer influences of the mobile device is required. A terminal portable cover does not only provide protection but can also convert the mobile device into a scanner by by connecting to the devices camera and display which enhances the usability of the mobile device and enables the user to easier scan the electronic instrument.

Another one of those preferred further developments of the disclosed method comprise that a built-in digital camera of the mobile device is used to read a product code, notably a one-dimensional barcode or a two-dimensional Datamatrix-Code, preferably a QR-Code, from the remote controlled instrument to identify it. The QR-or alternatively barcode which is printed on an label attached to the instrument contains the information which kind of instrument it is and which type of GUI is required to remote control it. When scanning it with the camera of the mobile device the software uses its integrated bar-/QR-code reader function to acquire the saved information. With the successful identification the correct GUI can then be loaded on the mobile device and used by the user for controlling the instrument.

Another one of those preferred further developments of the disclosed method comprise that the mobile device uses NFC to scan a RFID tag having a unique ID attached to the instrument. The mode of operation for an RFID tag is in principle the same as for the barcode. Only that here not the camera of the mobile device is used to acquire the information about the instrument type but its builtin NFC (Near Field Communication) function. If a specific counterfeight needs to be ensured, a physical uncloneable function (PUF) or the like which enables an unforgeable data transfer can also replace the RFID. This can be realized by a so called pChip. In this case a pPChip reader needs to be connected to the mobile device as standard smartphones usually don't have such a pChip reading function.

Another one of those preferred further developments of the disclosed method comprise that the built-in digital camera of the mobile device is used and the software is enabled to detect the shape and/or specific pictograms or tags attached to the instrument. Alternatively to using barcodes or RFIDs the mobile device can us simply its camera to image the instrument and uses its software to identify the instrument. Here the software uses digital image processing algorithms, like edge detection and the like, to recognize the instrument by identifying its unique shape. Additionally or alternatively also specific pictograms or tags which disclose a serial number and which are attached to the instrument can be recognized by the software.

Another one of those preferred further developments of the disclosed method comprise that when a mobile device is not paired to a single instrument, it automatically activates a Fleet Management Mode and shows all available instruments in its fleet which can be remote controlled by the mobile device. This functions helps to show the user all available instruments which he can remote control with the mobile device. Usually this Fleet Management Mode is active before the user pairs with and logs to a specific instrument and/or after he unpairs. Which instruments are exactly shown in this mode depends on the settings. E.g. could only the active instruments which respond to a broadcast or send broadcast messages themselves be shown. Or all instruments to which the mobile device had been connected in the past could be shown.

Another one of those preferred further developments of the disclosed method comprise that for a remote control of the instrument a wired or wireless data connection is established between the mobile device and the instrument using a specific data protocol to exchange necessary control data and commands entered by a user between the graphical user interface of the mobile device and the instrument. While a wired connection, e.g. via an USB cable, between mobile device and instrument is possible, a wireless connection is usually much more convenient. Preferable solutions are technologies like Bluetooth or a Wifi connection, be it either a direct coupling or indirect via a network. If that is not available also 4G/5G can be an option. Another point is which kind of software protocol is used for the communication between device and instrument. The protocol needs to offer and implement the interface and determines how the necessary transferred data, like control commands, status data or even the GUI data itself if it is transferred directly, is structured.

Another one of those preferred further developments of the disclosed method comprise that the mobile device is integrated into the instrument to provide the instruments direct input terminal and display screen. By using this solution the mobile device can be integrated into the equipment. Here the pairing between the smartphone and the equipment is no longer mandatory. When a user access this specific instrument via the user interface of the instrument provided by the mobile device, other users can be blocked and notified. The integration can be done by simply connecting the mobile device by wire with the instrument. The mobile device then uses its own input hardware, e.g. a touch screen, to provide the user interface which can then be directly used by a user to control the instrument. Also other ways of integration are possible, like a specific socket with an USB connection where you can simply place the mobile device.

Another one of those preferred further developments of the disclosed method comprise that Chemical Labratory Instruments, Quality Controls Labs instruments or Production Lines instruments are used as remote controlled instrument. While the invented method can be applied to every electronical instrument it is especially suitable to be used with Chemical Labratory Instruments which are used in a Pharmaceutical industrial and/or a Food & Beverage industrial context.

Another solution to the task is a system configured to remote control different electronic instruments by performing the method steps of login and authentication of a user at the mobile device; scanning of an electronic instrument to be remote controlled with the mobile device to identify the instrument by the user; performing an security check by the mobile device if the authenticated user is authorized to control the identified instrument; if the user is authorized pairing of the mobile device with the instrument and loading the correct compatible graphical user interface of the paired instrument and displaying it at the screen of the mobile device; remote controlling of the instrument by; and using the graphical user interface displayed on the mobile device.

### DETAILED DESCRIPTION OF THE INVENTION

The method and the used system of the invention and functionally advantageous developments of those are described in more detail below with reference to the associated drawings using at least one preferred exemplary embodiment. In the drawings, elements that correspond to one another are provided with the same reference numerals.

### THE DRAWINGS SHOW

FIG. 1: a schematic overview about the invented method

FIG. 2: a mobile device during the login step

FIG. 3: the mobile device during the scan of an instrument

FIG. 4: the pairing of the two components

FIG. 5: the fleet management

FIG. 6: the mobile device during the logoff step

FIG. 7: an overview about all interactions

FIG. 8: an alternative approach without pairing

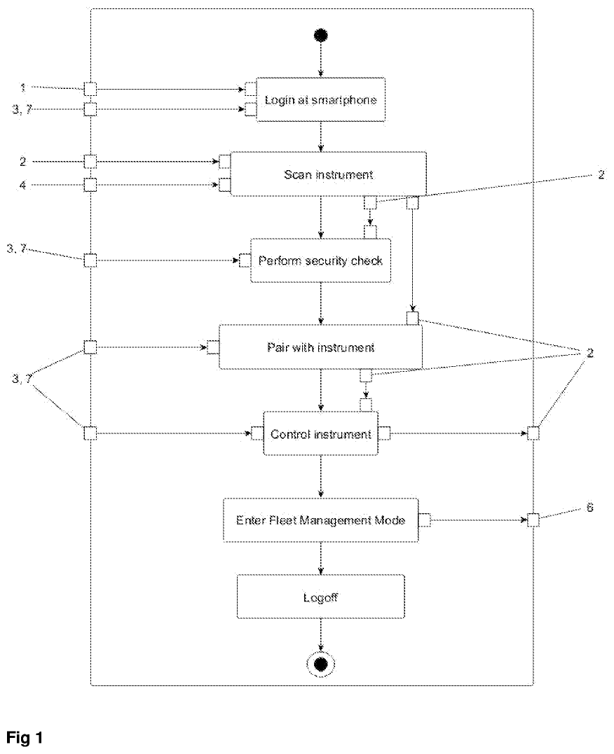

The hereby presented invention intends to rely on mobile devices 1, preferably but not limited to a standard smartphone 1, as a central user interface 5 (preferably a GUI) for different type of instruments 2 and for the instrument fleet management 6. This also solves the issue of managing the multiple different user managements which are linked to each instrument 2. The user logges in on its smartphone 1 and gets access to the respective configured software application app 7, furthermore called app 7, which allows him to remote control the connected instruments 2. FIG. 1 shows this approach in a schemativ overview.

In a further embodiment a ruggedized Terminal Portable Reader, like the MX-1000 barcode reader, is used additionally to the smartphone 1. This allows to ruggedize the smartphone 1 so it can be used in an industrial environment and at the same time convert it to a barcode reader thanks to its dedicated application programmers interface (API).

The use of smartphones 1 as mobile devices 1 in this invented method brings the benefit of having always the latest technologies for the tertiary connectivity which therefore doesn't need to be built in the instrument 2 anymore. The instrument 2 just needs a standard connection interface to communicate with the smartphone 1 like Bluetooth or WiFi. This leads to a substantial cost reduction with a better life cycle management because of the obsolescence of displays, aging protocols, etc and lowers the cost for regulatory approval for the instruments 2 as smartphones 1 are considered as an already approved module.

Another benefit is that the instrument 2 doesn't need a Real Time Clock (RTC) anymore and the challenge of synchronizing the time of the instrument 2 and the local time is removed as the smartphone 1 get is own clock that can be synchronized over its internet connection.

The graphical user interface 5 of the instrument can be duplicated on the smartphone 1 once the instrument 2 has been selected. The preferred mode of operation is to scan the product code 4 of the instrument 2, which contains a unique ID with the Instrument type and the serial number, and get straight into the GUI 5 of this instrument 2 if the user 3 is authorized to use the instrument 2.

The barcode reader is therefore a central part of the pairing process in order to get rid of connectivity features on the instruments 2. Of course, the pairing can also use different technology which is available on the smartphone 1. One further embodment uses NFC—which means there is a RFID tag having a unique ID attached to each instrument. If counterfeight plays a role, a PChip can also replace the RFID in another further embodiment which then requires a PChip reader connected to the smartphone 1.

In another embodiment the camera of the smartphone 1 is used to recognize the instrument type and serial number. Here the software app 7 uses augmented really algorithms to detect the shape and/or special pictograms or tags on the instruments 2 to determine model and serial number.

As already mentioned the instrument 2 still needs a kind of standard data interface to transfer some data from the instrument 2 to the smartphone 1. This data is required to display the user the GUI and with the GUI the status of the connected instrument 2. The graphical user interface 5 also allows him to send control commands to the instrument 2. If the smartphone 1 is integrated in or always nearby located to the instrument 2 this can be done by a wire, e.g. an USB wire. Otherwise it needs to leverage a wireless technology. In preferred embodiments an intemporal technology such as Bluetooth or WiFi is used.

Another feature of all preferred embodiments is that when a mobile device is not anchored respectively paired to a single instrument 2, it goes in a Fleet Management Mode 6 in order to control, command or setup other instruments 2 of the fleet. In this mode all available instruments 2 which are connected via their data interface in the used network are shown on the GUI 5 to the user 3. It depends on the configuration of the whole system if in the Fleet Management Mode 6 the available instruments 2 only show their current status or if control actions can be performed by the user 3 as well. If the latter is the case it needs to be ensured that instruments 2 which are currently paired or anchored to another mobile device 1 cannot be controlled at the same time the first mobile device 1 in Fleet Management Mode 6.

In the following it will be explained with several figures how a typical use of the invented solution with a smartphone 1 as mobile device 1 which is used also as a barcode reader will be in a preferred embodiment.

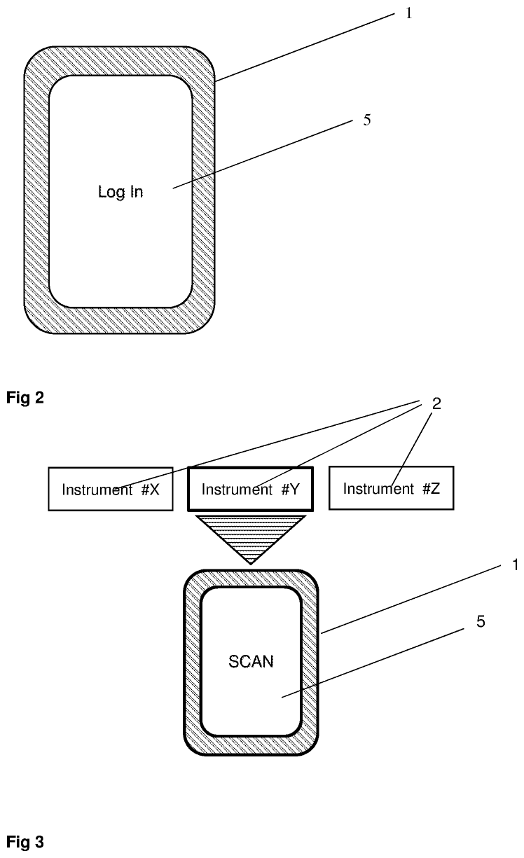

Step 1-FIG. 2: Log in the smartphone 1
This login step can rely on single sign on of a company (LDAP) and/or rely on such google or Microsoft double authentication process.

Step 2-FIG. 3: Scan the instrument 2 which is to be remote controlled
For the scanning step there are two options: If the user 3 is not authorized, he gets a respective notification via the GUI and is denied access. If he is authorized, access will be granted step three is started.

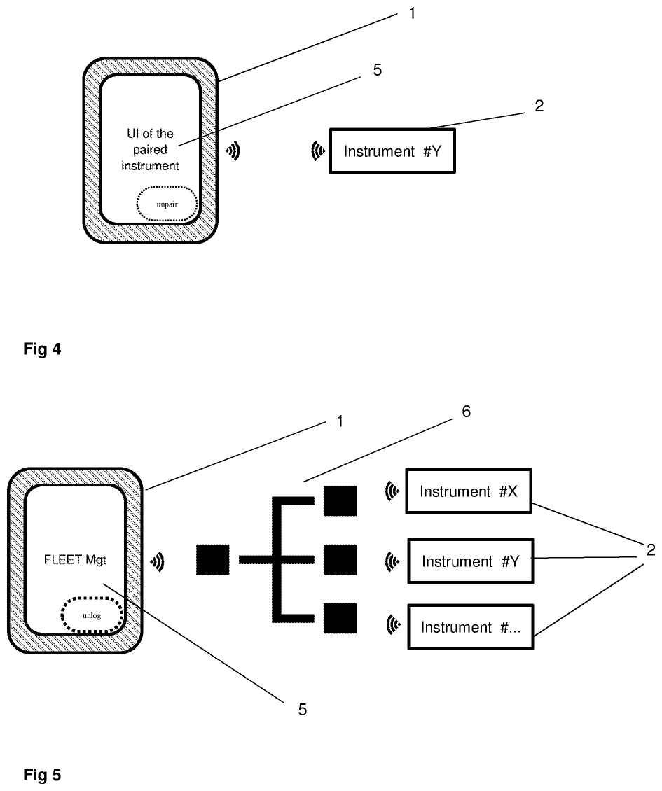

Step 3-FIG. 4: Pairing
The instrument 2 and the smartphone 1 are paring and the GUI 5 of the paired instrument 2 is displayed.

Step 4-FIG. 5: Unpairing and fleet management After the user 3 has ended with controlling this instrument 2, he can unpair the instrument 2 and gets automatically to the Fleet Management Mode 6, where he can check other available instruments 2 either by checking their status in the Fleet Management Mode 6 or by pairing again with a single instrument 2 leaving the Fleet Management Mode 6.

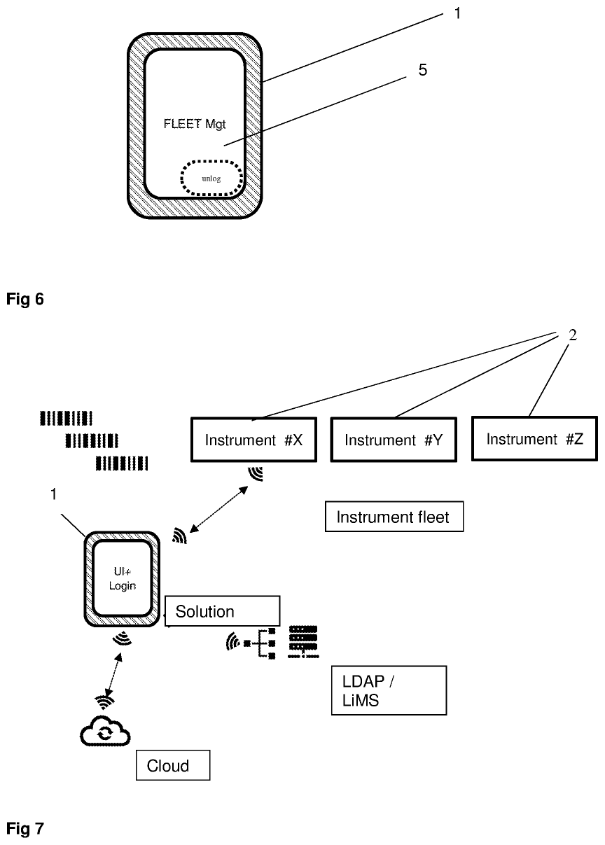

Step 5-FIG. 6: Unlogging
At any moment the user can logoff from the user interface (GUI) 5 and the app 7 and end the session. If performing a logoff the Fleet Management Mode 6 is not activated.

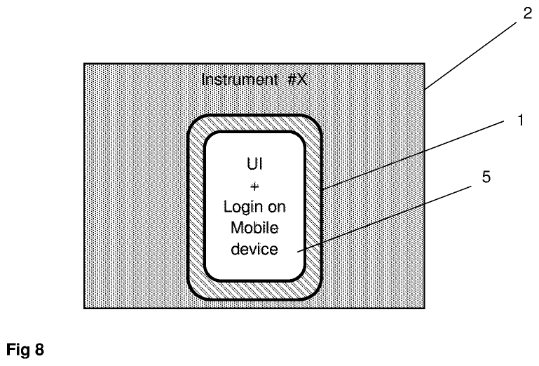

FIG. 7 shows an overview about all possible interactions in this preferred embodiment.

In another embodiment the smartphone 1 can also be integrated into the instrument 2 in order to get rid of the pairing need between the smartphone 1 and the instrument 2. When a user 3 access the instrument 2 via the GUI of the smartphone 1, other users can be blocked and notified through the cloud. FIG. 8 shows an example how this function would work. The integration of the smartphone 1 into the instrument 2 is done, as mentioned above, by connecting the smartphone 1 by wire, especially USB, to the instrument 2. It is also possible to use a socket which uses any suitable connection technology to integrate the smartphone 1 with the instrument 2. Or the instrument 2 itself provides a kind of a hardware interface where the smartphone 1 can be inserted. The smartphone 1 with the app 7 and its GUI 5 acts then as the primary input terminal of the instrument 2.

To establish the conncection between the mobile device 1 respectively its software app 7 and the different instruments 2 a communication protocol is needed. Several preferred embodiments of this protocol is explained in the following:

For Internet-of-Things (IoT) environments, local “edge” devices, typically sensors, collect data and send it to a data center—“the cloud”—for processing. Getting the data to the cloud requires communicating using the standard IP protocol stack. This can be done by directly connecting the edge devices via the Internet to the data centers—the “cloud model.” Or, it is possible to communicate from the edge devices to a collection point known as a border gateway to have the data relayed from there to the data center—the “fog model.””

In this case, the sensors are the instruments 2 and the ‘border gateway’ is the mobile device 1 that is also hosting the deported/remote Graphical User Interface (GUI) 5. The communication between the instruments 2 and the mobile device can use radio (e.g WiFi and/or Bluetooth) or a cable.

The preferred mode of operation depends on the application:
If the mobile device 1 is embedded in the instrument 2, then the cable is preferred.
If the mobile device 1 is ‘outside’ the instrument 2 and provides the local GUI 5 of instruments 2 one by one, then Bluetooth is preferred.
If the purpose is to have a fleet management 6, then a permanent connection to a cloud would be needed and WiFi is preferred.

For the preferred embodiment WiFi is used because during the Fleet Management Mode 6 the mobile device 1 is not always in the same lab as all instruments 2 and therefore some might be out of the range of the Bluetooth.

All modes of operation are compatible with each other. For instance, the instrument 2 can have both Bluetooth/WiFi installed, the Bluetooth being used to remote the local GUI 5 of the instrument 2 when paired to the mobile device 1, and the WiFi being used to be connected to the Cloud and allow the fleet management 6, even when there is no local GUI 5 available.

The WiFi/Bluetooth connectivity of the instrument 2 can also come from another Mobile device being embedded in the instrument 2 and connected to the mainboard with a cable.

The local GUI 5 can be deported to the network via ‘tunneling’. In this case, the instrument 2 messages are tunneled via the selected protocols to the network. The mobile device 1, e.g. a smartphone 1, can do this tunneling even if there is no WiFi by leveraging the 4G/5G and therefore the service comes from the cellular provider.

Any Machine to Machine (M2M) protocols can work for the invention but some will have a best fit with the technology being used for the connectivity. In Industrial IoT (Internet of Things), it is preferred to use Modbus, Profibus or Profinet protocols with the capability to command and control the instrument 2 by reproducing the full state of the instrument 2 remotely. The Client Modbus TCP is then the mobile device 1 and the Servers Modbus are the instrument 2s.

In IoT, it is also preferred to leverage the RESTFul API or MQQT protocols. These protocols were built to work on the Web and fits with HTTP. Therefore, a local network between the instrument 2 and the mobile device is created. The instrument 2s act as Servers and the mobile device 1 acts as Client.

In Laboratory (Lab) IoT emerging protocols like SiLA2 are used. SiLA 2 considers every entity in the modern laboratory as a service and rely on HTTP/2. In this architecture, the SiLA Server(s) are the instrument(s) 2 and the SiLA Client is the mobile device 1.

In the consumer electronics, like audio, headset, mouse, etc, Bluetooth is used. Each application takes benefit of a specific Bluetooth profiles. The one of interest for instruments 2 is the Serial Port Profile (SPP). Indeed, using SPP, each connected device can send and receive data just as if there were RX and TX from UART protocol lines connected between them. Two Arduinos, for example, could converse with each other from across rooms.

In instrument design, it is also possible to use custom solutions such as specific drivers and/or DLL and/or Command Line Interface and/or simple binary protocols to communicate with the instrument 2. The mobile device 1 is then relying on this custom solution in background of the GUI 5 in order to interact with the instruments 2.

For the local GUI 5 in the ‘fog’ model there are no preferred protocols and one could interact with the others. When using the fleet management 6 that needs to communicate with instruments 2 outside from one Lab and/or plant, the ‘cloud model’ which will take benefit of having a web optimized protocol such a MQTT or ‘tunneling’ is used.

Therefore, the preferred mode of operation is to use Bluetooth/SPP in the Lab with the ‘fog model’ for the remote local GUI 5 and WiFi/MQTT for the fleet management 6 using the cloud model.

### LIST OF REFERENCES

1 Mobile Device (Smartphone)
2 Instrument
3 User
4 Product Code (QR-Code or RFID)
Graphical User Interface (GUI)
6 Fleet Management Mode
7 Software App

1. Method to remote control different electronic instruments (2) by using a mobile computer device (1) with a software (7) including a compatible graphical user interface (5), the following steps comprising:
Login and Authentication of a user (3) at the mobile device (1);
Pairing of an electronic instrument (2) with the mobile device (1) to identify the instrument (2) by the user (3);
Performing an security check by the mobile device (1) if the authenticated user (3) is authorized to control the identified instrument (2);
If the user (3) is authorized pairing of the mobile device (1) with the instrument (2) via a data connection, loading of the correct compatible graphical user interface (5) of the paired instrument (2) and displaying it at the screen of the mobile device (1); and
Remote controlling of the instrument (2) by using the graphical user interface (5) displayed on the mobile device (1).

2. Method according to claim 1 wherein the login step is performed by using LDAP and/or a double authentication process.

3. Method according to claim 1 wherein a terminal portable cover is applied to the mobile device (1) that protects it from outside influences.

4. Method according to claim 1 wherein a built-in digital camera of the mobile device (1) is used to read a product code (4), notably a one-dimensional barcode or a two-dimensional Datamatrix-Code, preferably a GS1 datamatrix or QR-Code, from the remote controlled instrument (2) to identify it.

5. Method according to claim 1 wherein the mobile device (1) uses NFC to scan a RFID tag having a unique ID attached to the instrument (2).

6. Method according to claim 1 wherein the built-in digital camera of the mobile device (1) and is used and the software (7) is enabled to detect the shape and/or specific pictograms or tags attached to the instrument (2).

7. Method according to claim 1 wherein when a mobile device (1) is not paired to a single instrument (2), it automatically activates a Fleet Management Mode (6) and shows all available instruments (2) in its fleet which can be remote controlled by the mobile device (1).

8. Method according to claim 1 wherein for the pairing and remote control of the instrument (2) a wired or wireless data connection is established between the mobile device (1) and the instrument (2) using a specific data protocol to exchange necessary control data and commands entered by the user (3) between the graphical user interface (5) of the mobile device (1) and the instrument (2).

9. Method according to claim 1 wherein the mobile device (1) is integrated into the instrument (2) to provide the instruments (2) direct input terminal and display screen.

10. Method according to claim 1 wherein Chemical Laboratory Instruments, Quality Controls Labs instruments or Production Lines instruments are used as remote controlled instrument (2).

11. System configured to remote control different electronic instruments (2) by performing the method steps of claim 1.
